(19) United States
(12) Patent Application Publication
(10) Pub. No.: US 2012/0009448 A1
(43) Pub. Date: Jan. 12, 2012

(54) DIAGNOSTIC SYSTEM FOR THE INTERNAL STATUS OF A LITHIUM BATTERY

(75) Inventors: CHI-YUAN LEE, TAIPEI COUNTY (TW); SHUO-JEN LEE, TAIPEI COUNTY (TW)

(73) Assignee: YUAN ZE UNIVERSITY, TAOYUAN COUNTY (TW)

(21) Appl. No.: 12/831,534

(22) Filed: Jul. 7, 2010

(51) Int. Cl. H01M 10/48

(52) U.S. Cl. 429/90

(57) ABSTRACT

This invention relates to a diagnostic system for the internal status of a lithium battery. It includes a lithium battery unit, a plurality of sensor units and a control system. The lithium battery unit has a battery shell body and a lithium battery. The lithium battery is installed at the battery shell body. Each sensor unit comprises an electrically conductive wire and a sensor part. The internal part is disposed between the internal surface of the battery shell body and the lithium battery. The electrically conductive wire is connected respectively the sensor part and the control system so it can receive the data measured by the sensor part. The user can know the change inside the lithium battery. Therefore, it has the advantages and functions of real time monitoring, the enhancement of utilization safety, and the extension of product life.

### FIELD OF THE INVENTION

This invention relates to a diagnostic system for the internal status of a lithium battery. More specifically, it relates to a diagnostic system having a plurality of sensor units for detecting the internal status of a lithium battery. It has the advantages and functions of real time monitoring, the enhancement of utilization safety, and the extension of product life.

### DESCRIPTION OF THE PRIOR ART

Generally, when a Li-ion (lithium-lion) battery works under high power and fast charging or discharging, its internal temperature will rise rapidly. Then, Li ions will over-react to cause a great safety threat.

Furthermore, when the Li-ion battery is charging and discharging, the Li metal precipitated during the charging process will form a new active surface and react with the solvent of the electrolytic solution. Then, the internal impedance of the battery will rise. The discharging efficiency will be decreased. As the charging frequency increases, the battery capacity will decrease gradually. Hence, the Li metal precipitation process in the charging process will deteriorate the battery characteristics or even cause safety problems.

During fast charging and discharging process, the precipitated Li metal will form needle-like and twig-like crystal, which could cause many problems in the battery. Since the Li metal that forms needle-like or twig-like crystal has very large surface area, the occurrence probability of secondary reaction will be increased. The current efficiency will be lowered in accelerated way. When needle-like or twig-like crystalline Li metal penetrates isolation film, it will even cause short circuit between the positive and negative electrode. That will cause self-discharging of the battery. Such battery cannot be used. In the serious case, heat will be generated within the battery, or even explosion will occur.

During the re-charging process of Li-ion battery, the precipitation process of Li metal will increase. That will affect the penetration rate of Li ion and isolation film. Meanwhile, repeated charging and discharging will happen. Then, voltage and current will drop. Impedance will rise. Capacitance will drop. Finally, such over-charging will turn voltage and current unstable. That will cause safety problem eventually.

Therefore, it can be seen that during the charging and discharging process of Li ion battery, any abnormal change in temperature, voltage, and current is possible to cause utilization danger. Moreover, general Li ion battery does not have any internal test function. That is, during Li ion battery charging and discharging process, the user cannot know any abnormal change about internal temperature, voltage, and current. Thus, this might lead to the occurrence of accident.

FIG. 6 and FIG. 7 show the internal temperature distribution of a lithium battery during fast charging and discharging process when it is used in an electric vehicle. The elapsed time of FIG. 6 is 1200 seconds and the elapsed time of FIG. 7 is 3600 seconds. After the lithium battery is used for 1200 seconds, the internal side will form basically three areas of different temperatures, namely, first area A1, second area A2 and third area A3. Meanwhile, the temperature of first area A1 is 161° C., the temperature of second area A2 is 153° C., and the temperature of third area A3 is 145° C. After this lithium battery is used for 3600 seconds, the internal side will basically form two areas of different temperatures, namely, fourth area A4 and fifth area A5. Moreover, the temperature of fourth area A4 is 246° C., the temperature of fifth area A5 is about 232° C. Therefore, during the fast charging and discharging process of a lithium battery, high temperature will be generated and its temperature distribution will be very non-uniform. So, it is hard to monitor the internal temperature change inside a lithium battery. Hence, it is quite dangerous because of abnormal change of temperature or overheated condition.

In addition, the rise in voltage and temperature will lead the electrolytic solution generating gaseous CO₂. It would have certain danger if CO₂ is too much (it might eventually catch fire). Further, for a general lithium battery, no pressure sensor is installed. The user cannot know the situation of the gas inside the battery. Thus, it has certain degree of danger in utilization.

Therefore, it is needed to develop a new product to solve the above mentioned drawbacks and problems.

### SUMMARY OF THE INVENTION

The objective of the present invention is to provide a diagnostic system for the internal status of a lithium battery, which has advantages and functions such as: real time monitoring, the enhancement of utilization safety and the extension of utilization life, etc. This invention is to solve the incapability of internal monitoring and the subsequent safety problems caused in the prior art.

The technical means for solving the above mentioned problems in the present invention is to provide a diagnostic system for the internal status of a lithium battery comprising:

a lithium battery unit including a battery shell body and a lithium battery, the battery shell body having an internal surface and an internal space, the lithium battery being installed at the internal space of the battery shell body;

a plurality of sensor units, each sensor unit having an electrically conductive wire and at least a sensor part, the electrically conductive wire including a buried section and an exposed section, the buried section being installed between the internal surface of the battery shell body and the lithium battery, the exposed section being extending to an external side of the battery shell body; the sensor part being installed on the buried section so as to detect status of the lithium battery; and

a control system for connecting to the exposed section of the electrically conductive wire so as to receive data measured by the sensor part for knowing a situation of the lithium battery.

### BRIEF DESCRIPTION OF THE DRAWINGS

FIG. 1 illustrates a decomposition of diagnostic system for the internal status of a lithium battery of the present invention.

FIG. 2 illustrates the diagnostic system of internal status of a lithium battery of the present invention.

FIG. 3 is a perspective view illustrating the second embodiment of the present invention.

FIG. 4 illustrates the second embodiment of the present invention.

FIG. 5 is a view showing the control system of the present invention.

FIG. 6 illustrates the internal temperature change of a lithium battery of electric vehicle after the use of 1200 seconds.

FIG. 7 illustrates the internal temperature change of a lithium battery of electric vehicle after the use of 3600 seconds.

### DETAILED DESCRIPTIONS OF THE PREFERRED EMBODIMENTS

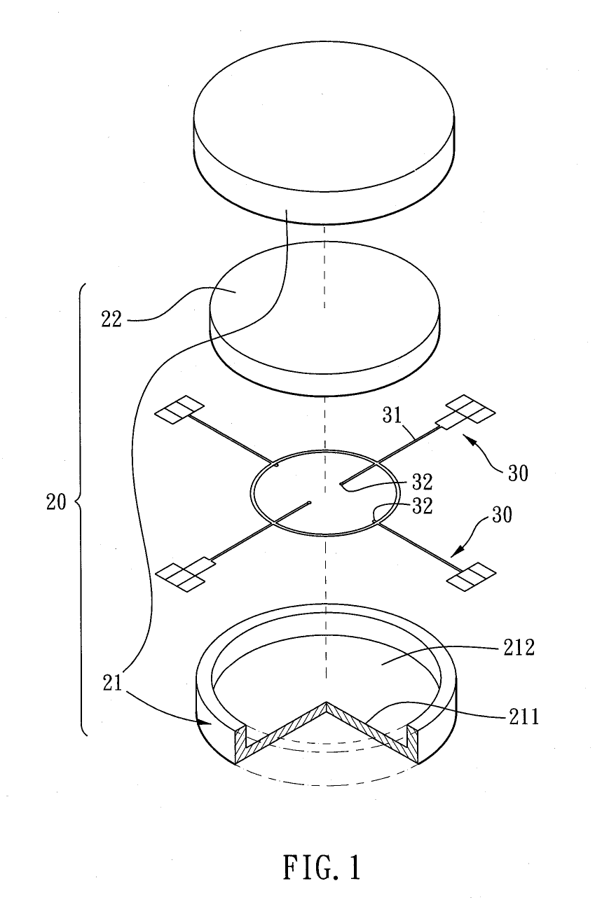

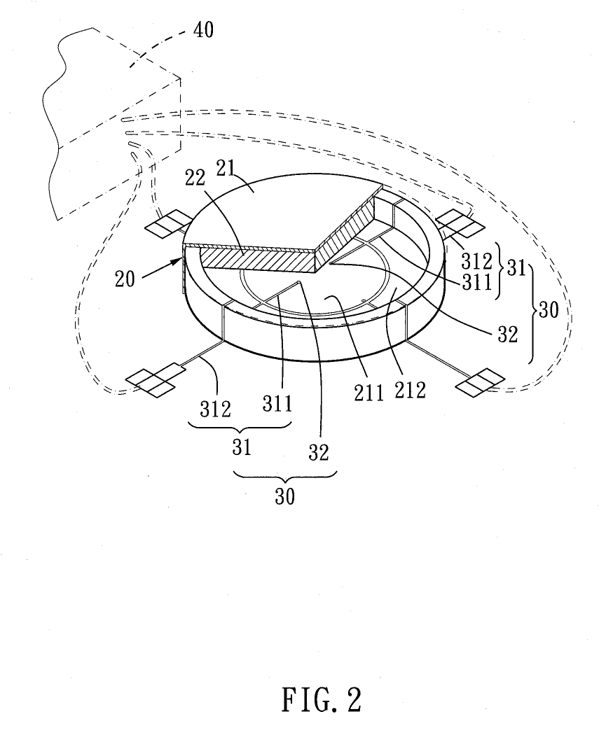

Referring to FIG. 1 to FIG. 2, the first embodiment of the present invention is disclosed. The present invention is a diagnostic system for internal status of a lithium battery. It mainly comprises a lithium battery unit 20, a plurality of sensor units 30, and a control system 30.

With regard to this lithium battery unit 20, it includes a battery shell body 21 and a lithium battery 22. The battery shell body 21 has an internal surface 211 and an internal space 212. Furthermore, the lithium battery 22 is installed at the internal space 212 of the battery shell body 21.

About these sensor units 30, each sensor unit 30 has an electrically conductive wire 31 and at least a sensor part 32. The electrically conductive wire 31 includes a buried section 311 and an exposed section 312. The buried section 311 is installed between the internal surface 211 of the battery shell body 21 and the lithium battery 22. The exposed section 312 extends to an external side of the battery shell body 21. The sensor part 32 is installed on the buried section 311 so as to detect the status of the lithium battery 22.

Concerning this control system 40, it is used for connecting to the exposed section 312 of the electrically conductive wire 31 so as to receive data (or signals) measured by the sensor part 32, and the user can know the situation of the lithium battery 22.

Furthermore, each sensor part 32 can measure the temperature, voltage value and current value where it is located. Based on the detection of these sensor parts 32, the change in charging and discharging process of each location of the lithium battery 22 is monitored in real time. Hence, when any abnormal change is occurred in the lithium battery 22, a safety protection action can be taken immediately to avoid the occurrence of accident (For example, it is used to detect a lithium battery installed on the electric vehicle that needs to charge or discharge frequently). The importance of temperature, voltage and current for the lithium battery 22 is described as follows.

[1] Temperature detection: Under high power as well as fast charging and discharging, the internal temperature of Li-ion battery will rise rapidly. The over-reaction of Li ion will cause a great safety threat. Moreover, the sensor part 32 of the present invention can make real time monitoring on the temperature of the lithium battery 22. When any abnormal change occurs, a necessary protection action can be done immediately at the time of occurrence so as to enhance its safety (For example, when the battery is overheated, the charging and discharging of the battery can be stopped immediately).

[2] Voltage and current detection: During the fast charging and discharging process of Li-ion battery, the precipitated Li metal will form needle-like and twig-like crystal, which will cause many problems in the battery. Since the surface area of formed needle-like and twig-like crystal of Li metal is very large, the occurrence probability of electrochemical reaction will be increased. Also, it will lower the current efficiency. Moreover, when an isolation film is penetrated by needle-like or twig-like crystal of Li metal, short circuit could happen between the positive and negative electrodes. Eventually, self-discharging of the battery will occur. This battery becomes useless. In the serious case, heat generation or even explosion are possible. During the repeated charging process of Li-ion battery, Li metal precipitation reaction will be increased, and the penetration rate of Li ion and isolation film will then be affected. At this moment, repeated charging and discharging will lower the voltage and current, raise the impedance, and lower the capacitance. Such over-charging will make voltage and current unstable. Finally, it will cause safety problems. Therefore, monitoring of voltage and current is needed.

Before monitoring this invention, the user can calculate the normal and safe range of the temperature, voltage and current of each location of the lithium battery 22. When the change of the temperature, voltage or current of the lithium battery 22 exceeds a normal range, the user can know it immediately and then can take necessary protection actions. In addition, if appropriate improvement is made when abnormal change occurs at each part of the lithium battery 22, the harm to the lithium battery can be reduced. Also, the product life can be prolonged. For the sensor part 32, not only it can detect the temperature, voltage, and current where it is located; but also it can detect the pressure it is located. By utilizing the pressure detection, when the lithium battery 22 generates CO₂, the sensor part 32 can know the quantity of CO₂. When the pressure in the lithium battery 22 exceeds the preset normal safe range, it can be known immediately and necessary protection actions can be taken.

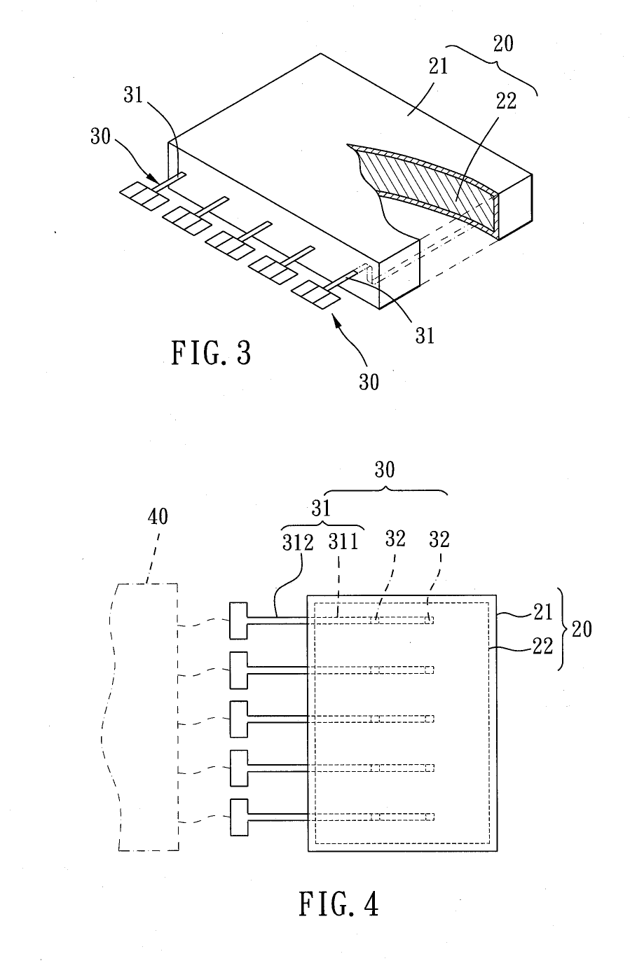

Of course, in real application, the arrangement of the sensor unit 30, the installation of the sensor part 32 on the buried section 311 and the quantity of the sensor part 32 can be modified depending upon the shape and volume, volume size, and location that needs to be detected of the lithium battery 22. For the first embodiment as shown in FIG. 1 and FIG. 2, the lithium battery unit 20 has a cylindrical volume and the electrically conductive wire 31 of the sensor unit 30 is basically evenly distributed radially. As shown in FIG. 3 and FIG. 4, which is the second embodiment of the present invention, the lithium battery unit 20 has a rectangular volume and the electrically conductive wire 31 of the sensor unit 30 is arranged evenly and substantially parallel (the sensor parts 32 are only shown in FIG. 4, not shown in FIG. 3). Meanwhile, each sensor unit 30 is disposed with two sensor parts 32.

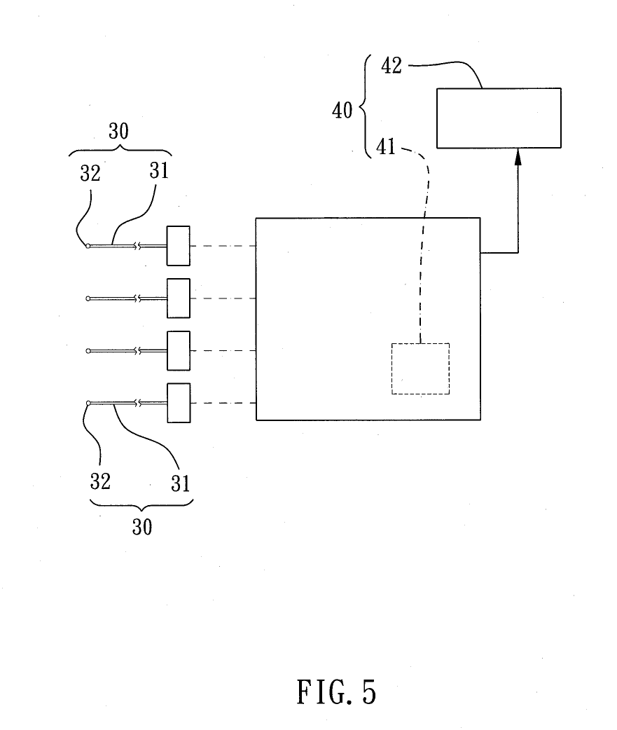

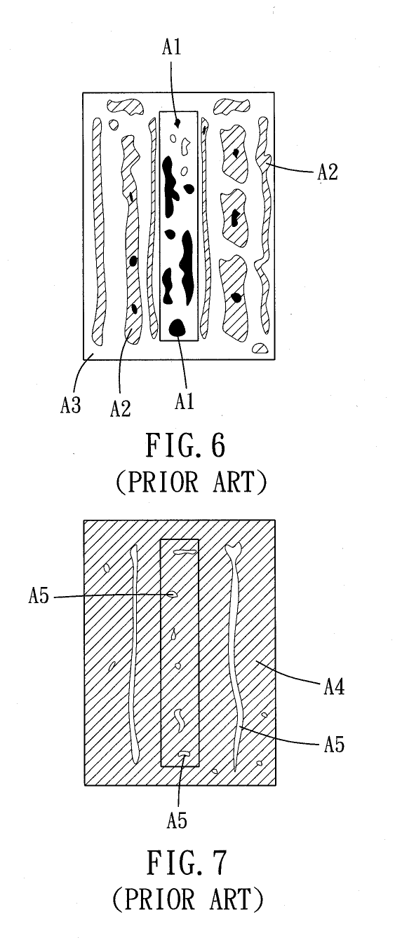

In addition, as shown in FIG. 5, the control system 40 has a processing part 41 and a display part 42. The processing part 41 is used to analyze and process the status of the lithium battery 22 measured by the sensor part 32 and display it on the display part 42.

Therefore, the advantages and functions of the present invention can be summarized as follows:

[1] Real time monitoring can be achieved. In the existing lithium battery, there is no detection function of temperature, voltage, current and pressure, and the internal change of lithium battery. So, nobody knows the internal status of the lithium battery. However, about the present invention, a plurality of sensor parts 32 are installed between the internal surface 211 of the battery shell body 21 and the lithium battery 22. Thus, the change in each part can be detected accurately and transmitted to the control system 40. Hence, the objective of real time monitoring can be achieved.

[2] The utilization safety can be enhanced. In the existing lithium battery, there is no detection function of temperature, voltage, current and pressure, and the internal change of lithium battery. Under this condition, danger could happen due to overheating, too much gas, and the instability in voltage or current. However, the present invention has the function of real time detection. When any abnormal change occurred in the lithium battery 22, it can be known immediately. Appropriate actions can be taken to avoid the occurrence of accident. Hence, it has the advantages of enhancing the utilization safety.

[3] It can prolong the product life. In the past, it cannot detect the change in each part inside a lithium battery. Therefore, no immediate improvement can be made. Accordingly, the product life of the lithium battery will be affected. However, for the present invention, the change of each part of the lithium battery 22 can be monitored in real time, and appropriate improvement can be made. The danger about the lithium battery 22 can be reduced. Of course, the product life can be prolonged.

The above is only description of better embodiment of the present invention, and any simple modification and change of the embodiment should be within the scope of what is claimed.

What is claimed is:

1. A diagnostic system for internal status of a lithium battery comprising:
a lithium battery unit including a battery shell body and a lithium battery, said battery shell body having an internal surface and an internal space, said lithium battery being installed at said internal space of said battery shell body;
a plurality of sensor units, each sensor unit having an electrically conductive wire and at least a sensor part, said electrically conductive wire including a buried section and an exposed section, said buried section being installed between said internal surface of said battery shell body and said lithium battery, said exposed section being extending to an external side of said battery shell body; said sensor part being installed on said buried section so as to detect status of said lithium battery; and
a control system for connecting to said exposed section of said electrically conductive wire so as to receive data measured by said sensor part for knowing a situation of said lithium battery.

2. The diagnostic system for internal status of a lithium battery of claim 1, wherein said lithium battery unit has a cylindrical volume, and said electrically conductive wires on a plurality of sensor units that are evenly distributed and disposed radially.

3. The diagnostic system for internal status of a lithium battery of claim 1, wherein said lithium battery unit has a rectangular volume, and said electrically conductive wire of said sensor unit is arranged evenly and substantially parallel.

4. The diagnostic system for internal status of a lithium battery of claim 1, wherein said control system having a processing part and a display part, said processing part being provided for analyzing and processing said lithium battery status measured by said sensor part and displaying it on said display part.

5. The diagnostic system for internal status of a lithium battery of claim 1, wherein said sensor part is provided to detect temperature, voltage, and current of said lithium battery.

6. The diagnostic system for internal status of a lithium battery of claim 5, wherein said sensor part is provided to detect pressure of said lithium battery.
